(19) United States
(12) Patent Application Publication
(10) Pub. No.: US 2015/0116654 A1
(43) Pub. Date: Apr. 30, 2015

(54) Spectacles Article with Detachable Personal Accessories

(71) Applicant: Eyezoom Optics Inc., South El Monte, CA (US)

(72) Inventor: Feng Tang, Wenzhou (CN)

(73) Assignee: Eyezoom Optics Inc., South El Monte, CA (US)

(21) Appl. No.: 14/283,130

(22) Filed: May 20, 2014

(30) Foreign Application Priority Data
Oct. 31, 2013 (CN) 201320684578.4

(51) Int. Cl. G02C 5/20

(52) U.S. Cl. CPC G02C 5/20
USPC 351/116

(57) ABSTRACT

A spectacles article includes a pair of lenses, and a spectacles frame, which includes a lens frame, a first extension arm, a second extension arm and a personal accessory. The personal accessory is detachably attached on the spectacles frame to allow the spectacles frame to operate between a spectacles mode and an accessory mode, wherein in the spectacles mode, the personal accessory is securely attached on the spectacles frame, wherein in the accessory mode, the personal accessory is detached from the spectacles frame and is to be utilized as a personal accessory.

### BACKGROUND OF THE PRESENT INVENTION

1. Field of Invention

The present invention relates to spectacles, and more particularly to a spectacles article with at least one detachable personal accessory.

2. Description of Related Arts

Conventional spectacles usually comprise a spectacles frame and a pair of spectacles lenses. The spectacles frame usually comprises a pair of lens frames and a pair of extension arms rearwardly extended from two outer sides of the lens frames respectively.

A traditional disadvantage of the conventional spectacles as mentioned above is that the spectacles can only function as spectacles. In other words, the spectacles may be equipped with different kinds of lenses for correcting shortsightedness, long-sightedness, or for shielding sunlight and ultraviolet radiation. However, the spectacles may not perform any other function. In particular, when a user need to use certain kind of personal accessories (such as a comb) while wearing the spectacles, the user must get this item from somewhere else.

Thus, there is a need to improve upon conventional spectacles so as to allow them to better work with other kinds of personal accessories.

### SUMMARY OF THE PRESENT INVENTION

An objective of the present invention is to provide a spectacles article comprising a spectacles frame and at least one detachable personal accessory detachably provided on the spectacles frame.

Another objective of the present invention is to provide a spectacles frame which is capable of operating between a spectacles mode and an accessory mode, wherein in the spectacles mode, the personal accessory is securely attached on at least one of a corresponding lens frame, a first extension arm and a second extension arm, wherein in the accessory mode, the personal accessory is detached from the corresponding lens frame, the first extension arm and the second extension arm and is to be utilized as a personal accessory.

Another objective of the present invention is to provide a spectacles frame which may be used to accommodate a wide variety of personal accessories so that a user is able to conveniently utilize the personal accessory at any time and in any location.

Another objective of the present invention is to provide a spectacles article comprising a spectacles frame and a pair of lenses which may be used to assist the user in using the personal accessory.

In one aspect of the present invention, it provides a spectacles article, comprising:

a pair of lenses; and

a spectacles frame, which comprises:

a lens frame comprising a first frame member and a second frame member, the lenses being attached on the first frame member and the second frame member respectively;

a first extension arm rearwardly extended from the first frame member;

a second extension arm rearwardly extended from the second frame member; and

a personal accessory detachably attaching on at least one of the lens frame, the first extension arm and the second extension arm to allow the spectacles frame to operate between a spectacles mode and an accessory mode, wherein in the spectacles mode, the personal accessory is securely attached on the corresponding lens frame, the first extension arm and the second extension arm, wherein in the accessory mode, the personal accessory is detached from the corresponding lens frame, the first extension arm and the second extension arm and is to be utilized as a personal accessory.

### BRIEF DESCRIPTION OF THE DRAWINGS

FIG. 1 is a side view of a first extension arm and a personal accessory according to a preferred embodiment of the present invention.

FIG. 2 is a sectional side view of the first extension arm and the personal accessory according to the preferred embodiment of the present invention.

FIG. 3 is a first schematic diagram of the first extension arm according to the preferred embodiment of the present invention.

FIG. 4 is a second first schematic diagram of the first extension arm according to the preferred embodiment of the present invention.

FIG. 5 a plan view of a spectacles article according to the preferred embodiment of the present invention.

FIG. 6 is a perspective view of the first extension arm and a first accessory member according to the preferred embodiment of the present invention.

FIG. 7 is a perspective view of the second extension arm and a second accessory member according to the preferred embodiment of the present invention.

FIG. 8A and FIG. 8B are schematic diagrams of the spectacles article according to the preferred embodiment of the present invention, illustrating the operation of a third accessory member.

FIG. 9 is an alternative mode of the spectacles article according to the preferred embodiment of the present invention.

FIG. 10 is a schematic diagram of the first extension arm and the first accessory member according to the alternative mode of the preferred embodiment of the present invention.

FIG. 11 is a schematic diagram of the second extension arm and the second accessory member according to the alternative mode of the preferred embodiment of the present invention.

FIG. 12 is a perspective view of the second extension arm and the second accessory member according to the alternative mode of the preferred embodiment of the present invention.

FIG. 13 is a perspective view of the first extension arm and the first accessory member according to the alternative mode of the preferred embodiment of the present invention, illustrating that the first accessory member is engaged with the first extension arm.

FIG. 14 is a further illustration of the first extension arm and the first accessory member according to the alternative mode of the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

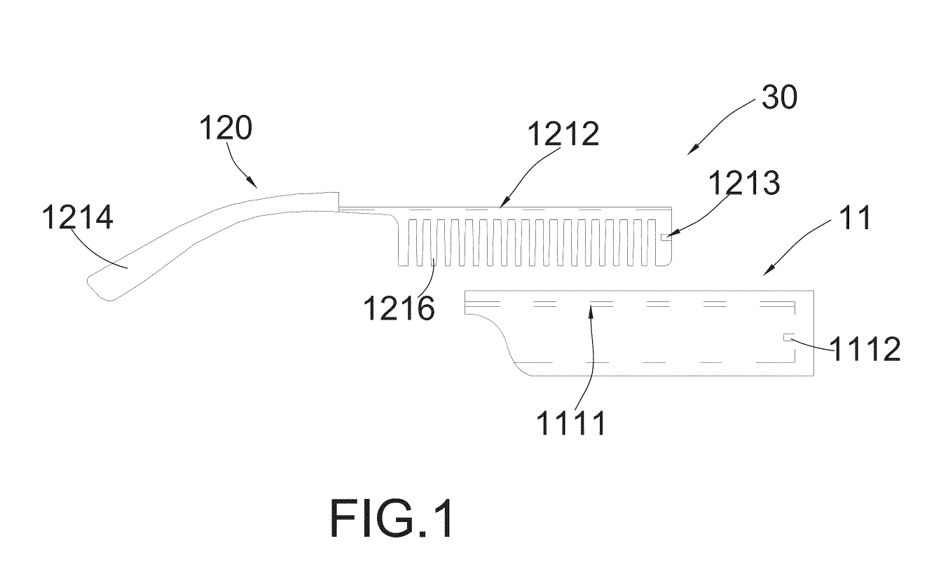

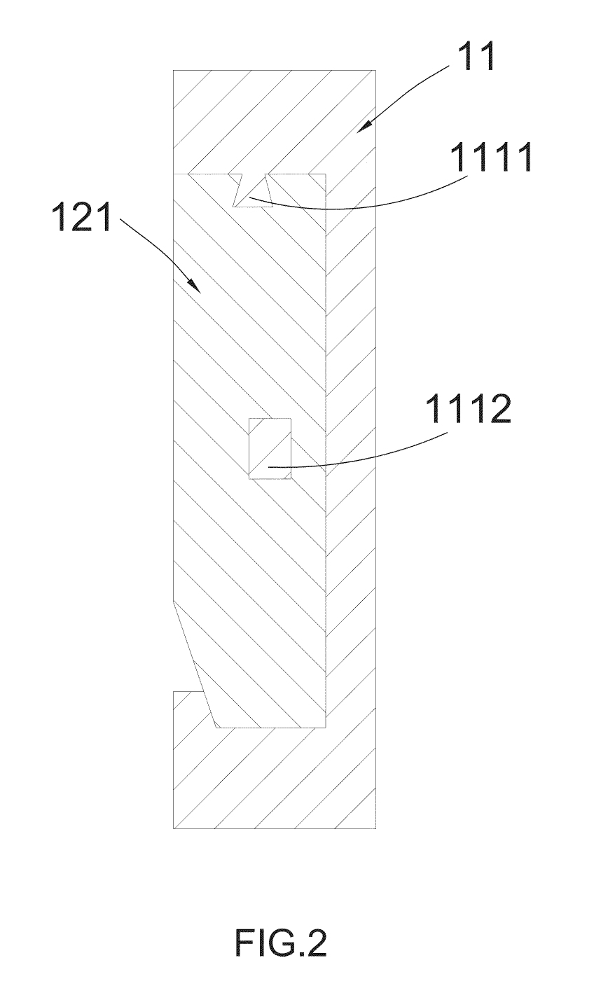

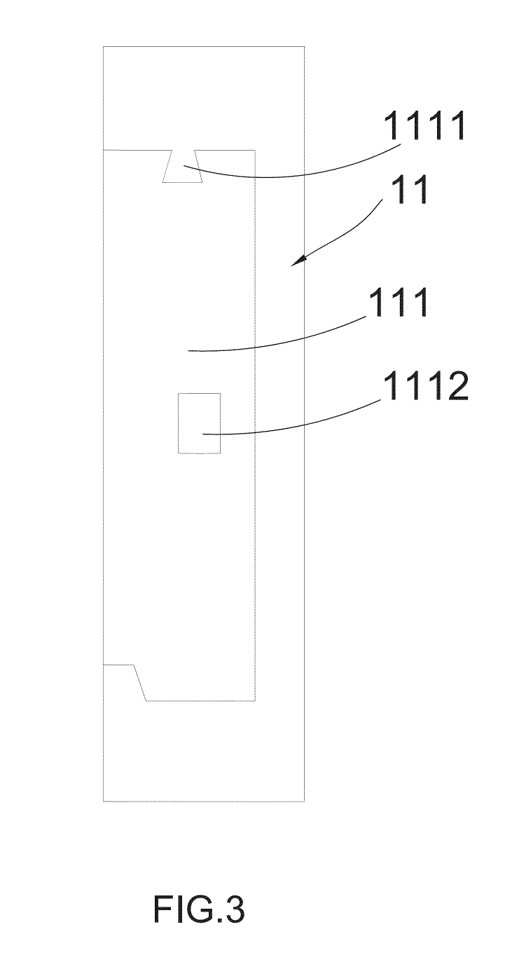

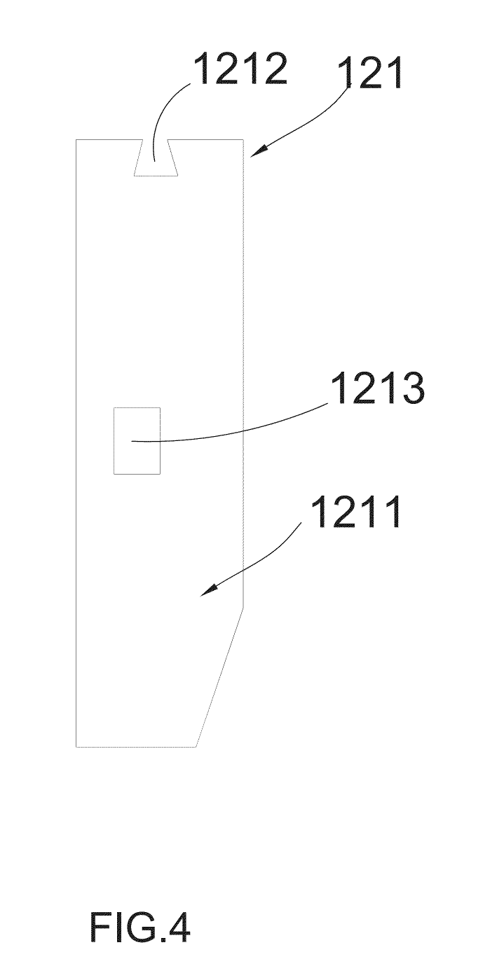

Referring to FIG. 1 to FIG. 7 and FIG. 8A to FIG. 8B of the drawings, a spectacles article 1 according to a preferred embodiment of the present invention is illustrated. Broadly, the spectacles article comprises a spectacles frame 10, a pair of lenses 20, and at least one personal accessory 30.

The spectacles frame 10 comprises a lens frame 2, a first extension arm 11 and a second extension arm 12. The lens frame 2 comprises a first frame member 21 and a second frame member 22. The first extension arm 11 is rearwardly extended from an outer side of the first frame member 21, while the second extension arm 12 is rearwardly extended from an outer side of the second frame member 22.

The personal accessory 30 detachably attaches on at least one of the lens frame 2, the first extension arm 11 and the second extension arm 12 to allow the spectacles frame 10 to operate between a spectacles mode and an accessory mode, wherein in the spectacles mode, the personal accessory 30 is securely attached on the corresponding lens frame 2, the first extension arm 11 or the second extension arm 12, wherein in the accessory mode, the personal accessory 30 is detached from the corresponding lens frame 2, the first extension arm 11 or the second extension arm 12, and is to be utilized as a personal accessory.

According to the preferred embodiment of the present invention, each of the first frame member 21 and the second frame member 22 has a cavity for accommodating the corresponding lens 20. The pair of lenses 20 can be specifically configured to correct shortsightedness, long-sightedness, or to block sunlight and ultraviolet radiation.

In the first preferred embodiment, the personal accessory 30 comprises a first accessory member 120 and a second accessory member 122 which are arranged to be detachably mounted on the first extension arm 11 and the second extension arm 12 respectively. The first extension arm 11 is elongated in shape and has a first mounting cavity 111 indently forming along a longitudinal direction of the first extension arm 11. In other words, the first extension arm 11 has an indention formed on an inner side thereof and surrounded by a first inner side surface 112, a first longitudinal surface 113, and a first transverse surface 114. Thus, the first mounting cavity 111 is surrounded by the first inner side surface 112, the first longitudinal surface 113, and the first transverse surface 114.

The first extension arm 11 further comprises a first longitudinal guiding ridge 1111 longitudinally formed on the first inner side surface 112 for guiding the personal accessory 30 (specifically the first accessory member 120) to slidably attach to or detach from the first extension arm 11. Note that a longitudinal length of the first longitudinal guiding ridge 1111 is slightly greater than a longitudinal length of the first inner side surface 112 so that the first longitudinal guiding ridge 1111 slightly protrudes along a longitudinal direction of the first inner side surface 112, and this slight protrusion is arranged to engage with the first accessory member 120.

Similarly, the second extension arm 12 is also elongated in shape and has a second mounting cavity 123 indently forming along a longitudinal direction of the second extension arm 12. In other words, the second extension arm 12 has an indention formed on an inner side thereof and surrounded by a second inner side surface 124, a second longitudinal surface 125, and a second transverse surface 126. Thus, the second mounting cavity 123 is surrounded by the second inner side surface 124, the second longitudinal surface 125, and the second transverse surface 126.

The second extension arm 12 further comprises a second longitudinal guiding ridge 1121 longitudinally formed on the second inner side surface 124 for guiding the personal accessory 30 (specifically the second accessory member 122) to slidably attach to or detach from the second extension arm 12. Note that a longitudinal length of the second longitudinal guiding ridge 1121 is slightly greater than a longitudinal length of the second inner side surface 124 so that the second longitudinal guiding ridge 1121 slightly protrudes along a longitudinal direction of the second inner side surface 124, and this slight protrusion is arranged to engage with the second accessory member 122.

The first extension arm 11 further comprises a first engagement member 1112 longitudinally protruded from the first transverse surface 114 for detachably engaging with the first accessory member 120. Similarly, the second extension arm 12 further comprises a second engagement member 1122 longitudinally protruded from the second transverse surface 126 for detachably engaging with the second accessory member 122.

Correspondingly, the first accessory member 120 has a first engagement slot 1213 formed on a front surface thereof, wherein a longitudinal axis of the first engagement slot 1213 is aligned with that of the first engagement member 1112 so that it can fittingly engage with the first engagement slot 1213. Similarly. The second accessory member 122 has a second engagement slot 1221 formed on a front surface thereof, wherein a longitudinal axis of the second engagement slot 1221 is aligned with that of the second engagement member 1122 so that it can fittingly engage with the second engagement slot 1221.

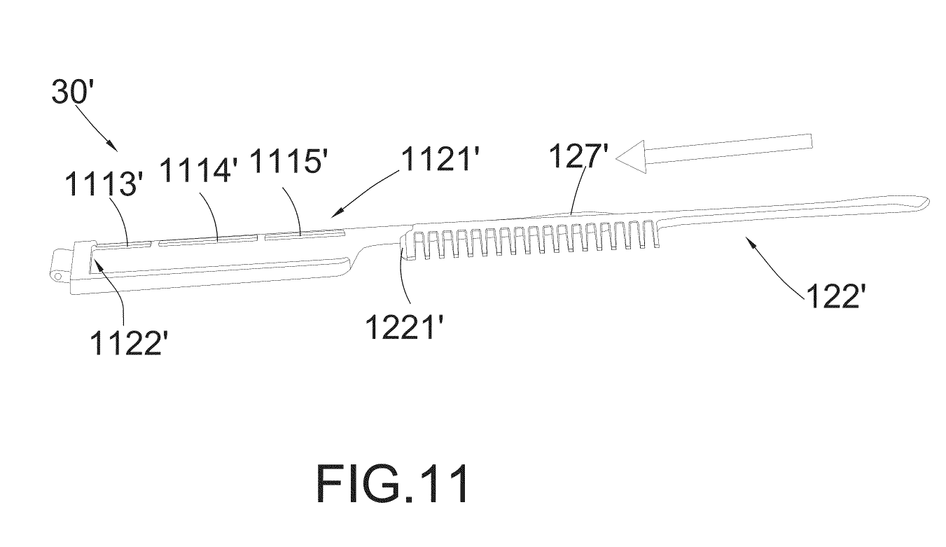

According to the preferred embodiment of the present invention, each of the first accessory member 120 and the second accessory member 122 is configured as a comb so that a user of the present invention may be able to selectively detach either one of them from the spectacles frame 2 and use it for managing his hair. It is important to mention, however, that the first accessory member 120 and the second accessory member 122 may also be configured to form other kinds of personal accessory such as a mirror (as shown in FIG. 11 below). As long as the first accessory member 120 and the second accessory member 122 can be attached on the spectacles frame 2, they can form any kind of personal accessory.

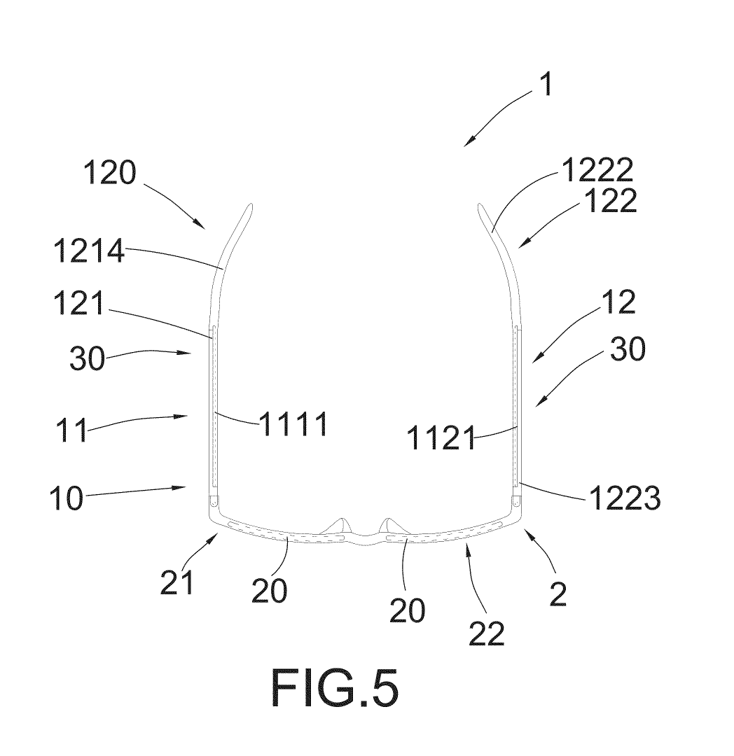

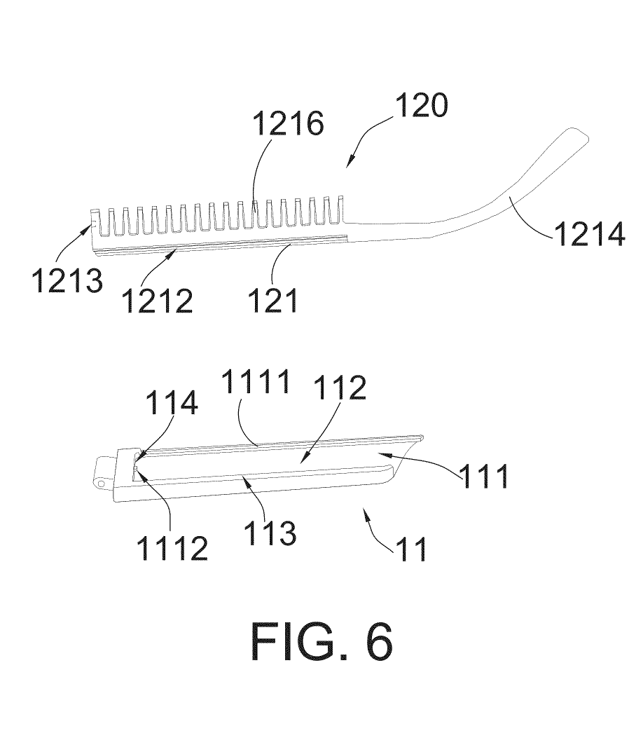

Thus, the first accessory member 120 comprises a first handle 1214, a first shaft 121 longitudinally extended from the first handle 1214, and a plurality of first teeth 1216 transversely extended from the first shaft 121. The first accessory member 120 has a first elongated slot 1212 longitudinally formed along the first shaft 121 and a front portion of the first handle 1214, wherein the first longitudinal guiding ridge 1111 is arranged to slidably insert into the first elongated slot 1212 for detachably attaching the first accessory member 120 onto the first extension arm 11. As shown in FIG. 5 and FIG. 6 of the drawings, a thickness of the first shaft 121 is slightly less than that of the first handle 1214 so as to allow the slight protrusion of the first longitudinal guiding ridge 1111 to insert into the first elongated slot 1212 formed on the first handle 1214. When the first accessory member 120 is mounted on the first extension arm 11, the first engagement member 1112 is also arranged to insert into the first engagement slot 1213. These engagements are designed to secure the position of the first accessory member 120 on the first extension arm 11.

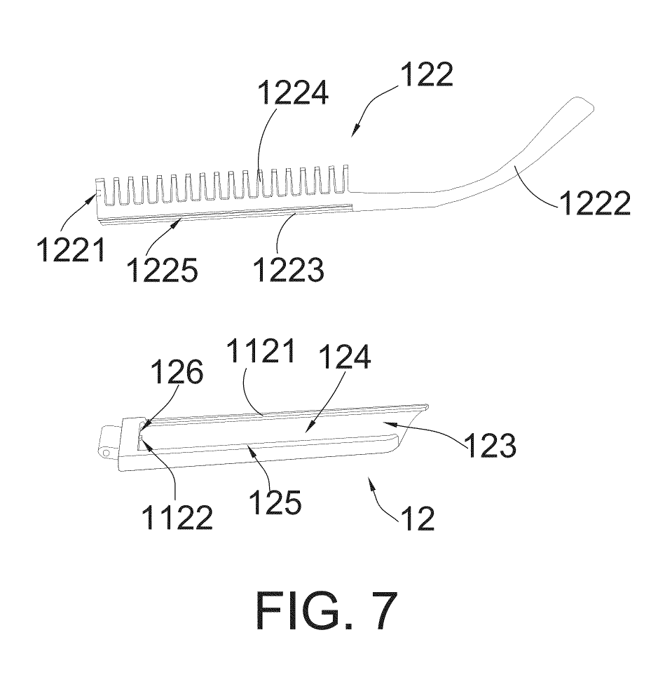

On the other hand, the second accessory member 122 comprises a second handle 1222, a second shaft 1223 longitudinally extended from the second handle 1222, and a plurality of second teeth 1224 transversely extended from the second shaft 1223. The second accessory member 122 has a second elongated slot 1225 longitudinally formed along the second shaft 1223 and a front portion of the second handle 1222, wherein the second longitudinal guiding ridge 1121 is arranged to slidably insert into the second elongated slot 1225 for detachably attaching the second accessory member 122 onto the second extension arm 12. As shown in FIG. 5 and FIG. 7 of the drawings, a thickness of the second shaft 1223 is slightly less than that of the second handle 1222 so as to allow the slight protrusion of the second longitudinal guiding ridge 1121 to insert into the second elongated slot 1225 formed on the second handle 1222. When the second accessory member 122 is mounted on the second extension arm 12, the second engagement member 1122 is also arranged to insert into the second engagement slot 1221. These engagements are designed to secure the position of the second accessory member 122 on the second extension arm 12.

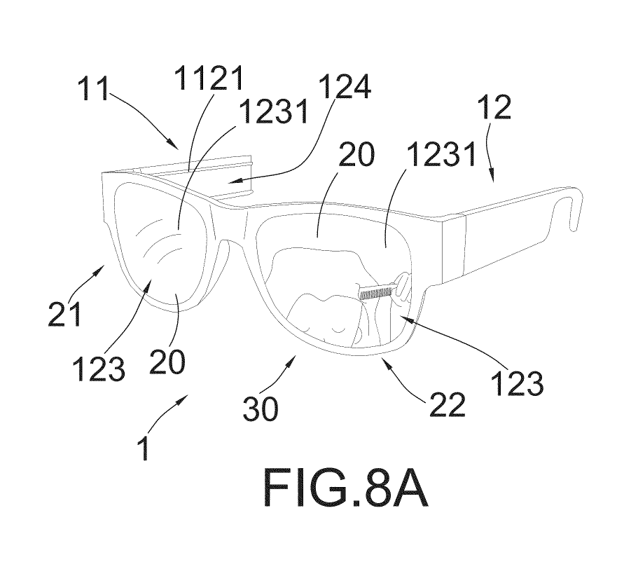

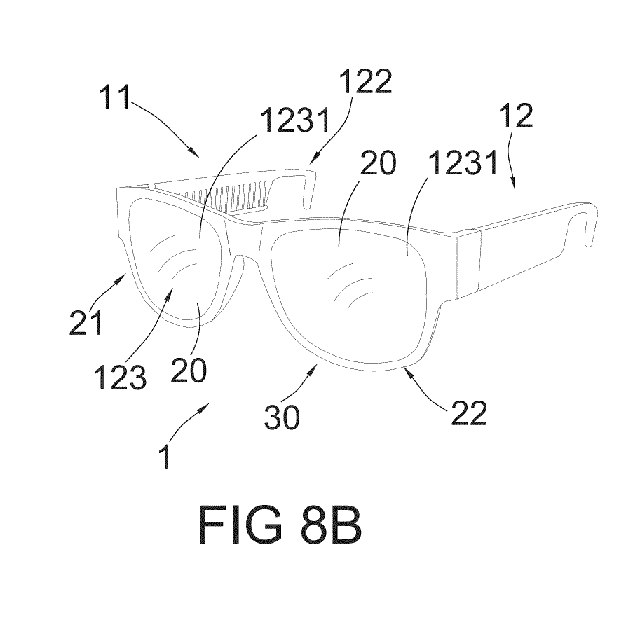

As shown in FIG. 8A and FIG. 8B of the drawings, the personal accessory 30 further comprises a third accessory member 123 which may be utilized for complementing the use of the first accessory member 120 and/or the second accessory member 122. In this preferred embodiment, the third accessory member 123 comprises a reflective medium 1231 coated on the lenses 20 so as to provide a visual image of the user's face when the user is utilizing the first accessory member 120 or the second accessory member 122. For example, the user of the present invention may detach the first accessory member 120 from the first extension arm 11 and use the reflective medium 1231 as a visual aid for managing his or her hair style by using first accessory member 11 as a comb.

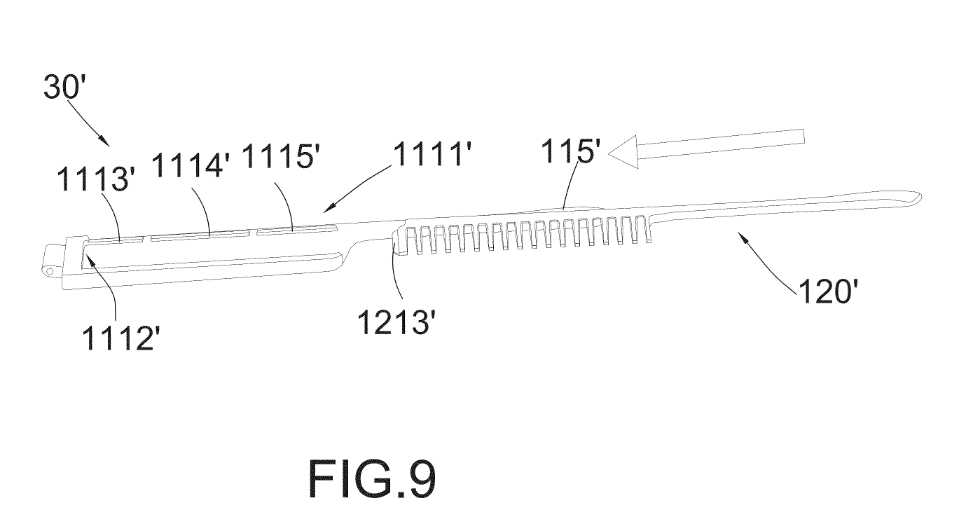

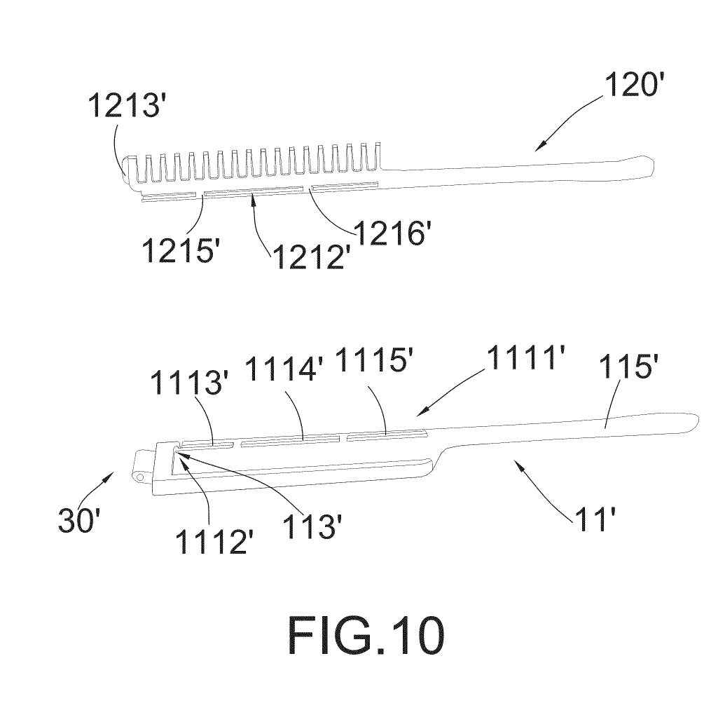

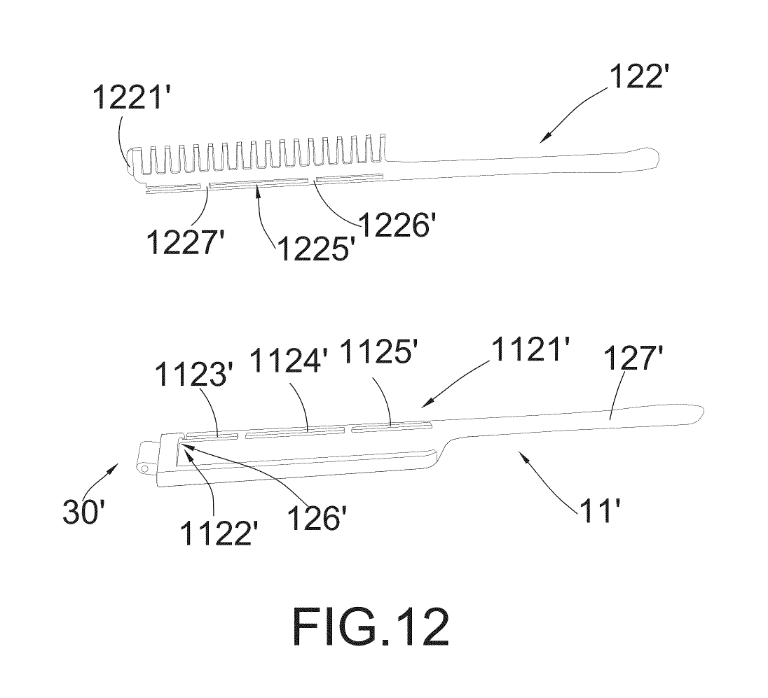

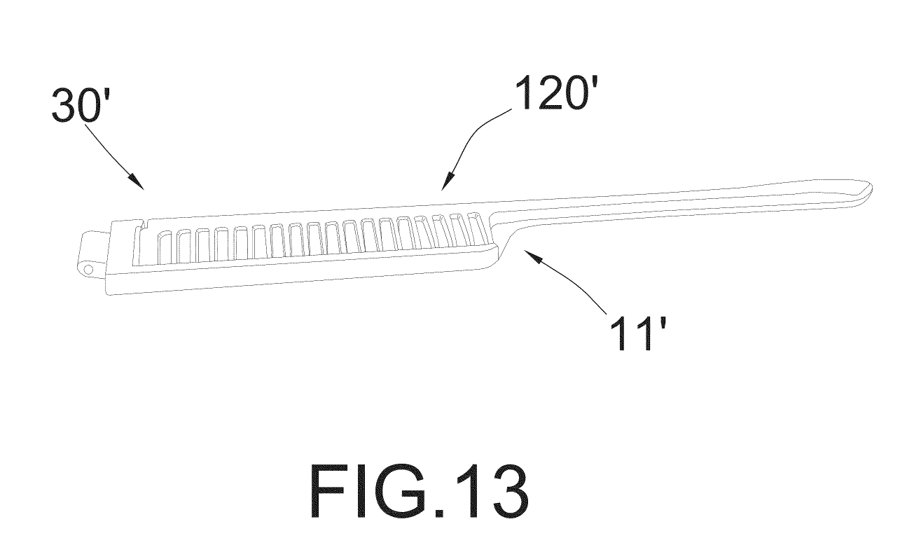

Referring to FIG. 9 to FIG. 13 of the drawings, an alternative mode of the spectacles article according to the preferred embodiment of the present invention is illustrated. In the alternative mode, the first longitudinal guiding ridge 1111′ of the first extension arm 11′ comprises first through third ridge sections 1113′, 1114′, 1115′ while the first accessory member 120′ further comprises a first securing member 1215′ and a second securing member 1216′ to divide the first elongated slot 1212′ into three sections. The first through third ridge sections 1113′, 1114′, 1115′ are arranged to engage with the three sections of the first elongated slot 1212′ respectively.

Similarly, the second longitudinal guiding ridge 1121′ of the second extension arm 12′ comprises fourth through sixth ridge sections 1123′, 1124′, 1125′ while the second accessory member 122′ further comprises a third securing member 1226′ and a fourth securing member 1227′ to divide the second elongated slot 1225′ into three sections. The fourth through sixth ridge sections 1123′, 1124′, 1125′ are arranged to engage with the three sections of the second elongated slot 1225′ respectively.

Moreover, the first extension arm 11′ further has a first engagement channel 1112′ indently formed on the first transverse surface 113′. Similarly, the second extension arm 12′ further comprises a second engagement channel 1122′ indently formed on the second transverse surface 126′. Accordingly, the first accessory member 120′ comprises a first engagement sleeve 1213′ formed on a front surface thereof in such a manner that the first engagement sleeve 1213′ is arranged to detachably insert into the first engagement channel 1112′. Similarly, the second accessory member 122′ comprises a second engagement sleeve 1221′ formed on a front surface thereof in such a manner that the second engagement sleeve 1221′ is arranged to detachably insert into the second engagement channel 1122′.

According to the first alternative mode of the present invention, the first extension arm 11′ has a first extension portion 115′ and the second extension arm 12′ has a second extension portion 127′. The first extension portion 115′ and the second extension portion 127′ are arranged to rest on the user's ears when the user is wearing the spectacles article. They can also act as handles when the user is using the personal accessory 30′. As a result, even when the first accessory member 120′ and the second accessory member 122′ are detached from the spectacles frame 10, the user is still able to wear the spectacles frame 10.

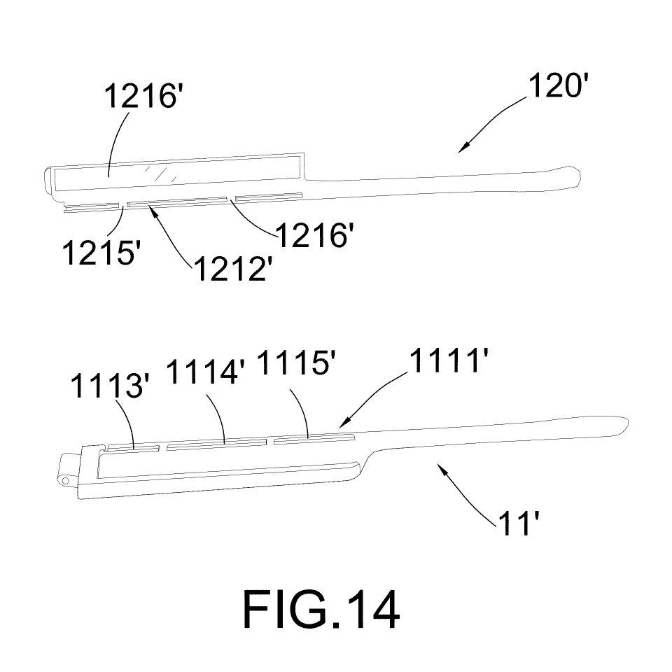

As a further illustration, as shown in FIG. 14 of the drawings, the first accessory member 120′ first teeth 1216 may be replaced by a mirror piece 1216′ and the user may use the first accessory member 120′ as a mirror instead of a comb.

The present invention, while illustrated and described in terms of a preferred embodiment and several alternatives, is not limited to the particular description contained in this specification. Additional alternative or equivalent components could also be used to practice the present invention.

What is claimed is:

1. A spectacles frame, comprising:
a lens frame comprising a first frame member and a second frame member;
a first extension arm rearwardly extended from said first frame member;
a second extension arm rearwardly extended from said second frame member; and
a personal accessory detachably attaching on at least one of said lens frame, said first extension arm and said second extension arm to allow said spectacles frame to operate between a spectacles mode and an accessory mode, wherein in said spectacles mode, said personal accessory is securely attached on said corresponding lens frame, said first extension arm and said second extension arm, wherein in said accessory mode, said personal accessory is detached from said corresponding lens frame, said first extension arm and said second extension arm and is to be utilized as a personal accessory.

2. The spectacles frame, as recited in claim 1, wherein said personal accessory comprises a first accessory member which is arranged to be detachably mounted on said first extension arm.

3. The spectacles frame, as recited in claim 2, wherein said personal accessory comprises a second accessory member which is arranged to be detachably mounted on said second extension arm.

4. The spectacles frame, as recited in claim 2, wherein said first extension arm further comprises a first longitudinal guiding ridge longitudinally formed on a first inner side surface of said first extension arm for guiding said first accessory member to slidably attach to or detach from said first extension arm, a longitudinal length of said first longitudinal guiding ridge being slightly greater than a longitudinal length of said first inner side surface so that said first longitudinal guiding ridge slightly protrudes along a longitudinal direction of said first inner side surface to engage with said first accessory member.

5. The spectacles frame, as recited in claim 3, wherein said second extension arm further comprises a second longitudinal guiding ridge longitudinally formed on a second inner side surface of said second extension arm for guiding said second accessory member to slidably attach to or detach from said second extension arm, a longitudinal length of said second longitudinal guiding ridge being slightly greater than a longitudinal length of said second inner side surface so that said second longitudinal guiding ridge slightly protrudes along a longitudinal direction of said second inner side surface to engage with said second accessory member.

6. The spectacles frame, as recited in claim 4, wherein said first extension arm further has a first transverse surface and comprises a first engagement member longitudinally protruded from said first transverse surface for detachably engaging with said first accessory member, said first accessory member having a first engagement slot formed on a front surface thereof, wherein a longitudinal axis of said first engagement slot is aligned with that of said first engagement member.

7. The spectacles frame, as recited in claim 5, wherein said second extension arm further has a second transverse surface and comprises a second engagement member longitudinally protruded from said second transverse surface for detachably engaging with said second accessory member, said second accessory member having a second engagement slot formed on a front surface thereof, wherein a longitudinal axis of said second engagement slot is aligned with that of said second engagement member.

8. The spectacles frame, as recited in claim 6, wherein said first accessory member comprises a first handle, a first shaft longitudinally extended from said first handle, and a plurality of first teeth transversely extended from said first shaft, said first accessory member having a first elongated slot longitudinally formed along said first shaft and a front portion of said first handle, said first longitudinal guiding ridge being arranged to slidably insert into said first elongated slot for detachably attaching said first accessory member onto said first extension arm, a thickness of said first shaft being slightly less than that of said first handle so as to allow said slight protrusion of said first longitudinal guiding ridge to insert into said first elongated slot formed on said first handle.

9. The spectacles frame, as recited in claim 7, wherein said second accessory member comprises a second handle, a second shaft longitudinally extended from said second handle, and a plurality of second teeth transversely extended from said second shaft, said second accessory member having a second elongated slot longitudinally formed along said second shaft and a front portion of said second handle, said second longitudinal guiding ridge being arranged to slidably insert into said second elongated slot for detachably attaching said second accessory member onto said second extension arm, a thickness of said second shaft being slightly less than that of said second handle so as to allow said slight protrusion of said second longitudinal guiding ridge to insert into said second elongated slot formed on said second handle.

10. The spectacles frame, as recited in claim 4, wherein said first extension arm further has a first elongated slot longitudinally formed thereon, said first longitudinal guiding ridge of said first extension arm comprising first through third ridge sections while said first accessory member further comprising a first securing member and a second securing member to divide said first elongated slot into three sections, said first through third ridge sections being arranged to engage with said three sections of said first elongated slot respectively.

11. The spectacles frame, as recited in claim 5, wherein said second extension arm has a second elongated slot longitudinally formed thereon, said second longitudinal guiding ridge of said second extension arm comprising fourth through sixth ridge sections while said second accessory member further comprising a third securing member and a fourth securing member to divide said second elongated slot into three sections, said fourth through sixth ridge sections being arranged to engage with said three sections of said second elongated slot respectively.

12. The spectacles frame, as recited in claim 10, wherein said first extension arm further has a first engagement channel indently formed on said first transverse surface, said first accessory member comprising a first engagement sleeve formed on a front surface thereof in such a manner that said first engagement sleeve is arranged to detachably insert into said first engagement channel.

13. The spectacles frame, as recited in claim 11, wherein said second extension arm further comprising a second engagement channel indently formed on said second transverse surface, said second accessory member comprising a second engagement sleeve formed on a front surface thereof in such a manner that said second engagement sleeve is arranged to detachably insert into said second engagement channel.

14. A spectacles article, comprising:
a pair of lenses; and
a spectacles frame, which comprises:
a lens frame comprising a first frame member and a second frame member, said lenses being attached on said first frame member and said second frame member respectively;
a first extension arm rearwardly extended from said first frame member;
a second extension arm rearwardly extended from said second frame member; and
a personal accessory detachably attaching on at least one of said lens frame, said first extension arm and said second extension arm to allow said spectacles frame to operate between a spectacles mode and an accessory mode, wherein in said spectacles mode, said personal accessory is securely attached on said corresponding lens frame, said first extension arm and said second extension arm, wherein in said accessory mode, said personal accessory is detached from said corresponding lens frame, said first extension arm and said second extension arm and is to be utilized as a personal accessory.

15. The spectacles article, as recited in claim 14, wherein said personal accessory comprises a first accessory member which is arranged to be detachably mounted on said first extension arm.

16. The spectacles article, as recited in claim 15, wherein said personal accessory comprises a second accessory member which is arranged to be detachably mounted on said second extension arm.

17. The spectacles frame, as recited in claim 15, wherein said first extension arm further comprises a first longitudinal guiding ridge longitudinally formed on a first inner side surface of said first extension arm for guiding said first accessory member to slidably attach to or detach from said first extension arm, a longitudinal length of said first longitudinal guiding ridge being slightly greater than a longitudinal length of said first inner side surface so that said first longitudinal guiding ridge slightly protrudes along a longitudinal direction of said first inner side surface to engage with said first accessory member.

18. The spectacles frame, as recited in claim 16, wherein said second extension arm further comprises a second longitudinal guiding ridge longitudinally formed on a second inner side surface of said second extension arm for guiding said second accessory member to slidably attach to or detach from said second extension arm, a longitudinal length of said second longitudinal guiding ridge being slightly greater than a longitudinal length of said second inner side surface so that said second longitudinal guiding ridge slightly protrudes along a longitudinal direction of said second inner side surface to engage with said second accessory member.

19. The spectacles frame, as recited in claim 17, wherein said first extension arm further has a first transverse surface and comprises a first engagement member longitudinally protruded from said first transverse surface for detachably engaging with said first accessory member, said first accessory member having a first engagement slot formed on a front surface thereof, wherein a longitudinal axis of said first engagement slot is aligned with that of said first engagement member.

20. The spectacles frame, as recited in claim 18, wherein said second extension arm further has a second transverse surface and comprises a second engagement member longitudinally protruded from said second transverse surface for detachably engaging with said second accessory member, said second accessory member having a second engagement slot formed on a front surface thereof, wherein a longitudinal axis of said second engagement slot is aligned with that of said second engagement member.

21. The spectacles frame, as recited in claim 19, wherein said first accessory member comprises a first handle, a first shaft longitudinally extended from said first handle, and a plurality of first teeth transversely extended from said first shaft, said first accessory member having a first elongated slot longitudinally formed along said first shaft and a front portion of said first handle, said first longitudinal guiding ridge being arranged to slidably insert into said first elongated slot for detachably attaching said first accessory member onto said first extension arm, a thickness of said first shaft being slightly less than that of said first handle so as to allow said slight protrusion of said first longitudinal guiding ridge to insert into said first elongated slot formed on said first handle.

22. The spectacles frame, as recited in claim 20, wherein said second accessory member comprises a second handle, a second shaft longitudinally extended from said second handle, and a plurality of second teeth transversely extended from said second shaft, said second accessory member having a second elongated slot longitudinally formed along said second shaft and a front portion of said second handle, said second longitudinal guiding ridge being arranged to slidably insert into said second elongated slot for detachably attaching said second accessory member onto said second extension arm, a thickness of said second shaft being slightly less than that of said second handle so as to allow said slight protrusion of said second longitudinal guiding ridge to insert into said second elongated slot formed on said second handle.

23. The spectacles frame, as recited in claim 17, wherein said first extension arm further has a first elongated slot longitudinally formed thereon, said first longitudinal guiding ridge of said first extension arm comprising first through third ridge sections while said first accessory member further comprising a first securing member and a second securing member to divide said first elongated slot into three sections, said first through third ridge sections being arranged to engage with said three sections of said first elongated slot respectively.

24. The spectacles frame, as recited in claim 18, wherein said second extension arm has a second elongated slot longitudinally formed thereon, said second longitudinal guiding ridge of said second extension arm comprising fourth through sixth ridge sections while said second accessory member further comprising a third securing member and a fourth securing member to divide said second elongated slot into three sections, said fourth through sixth ridge sections being arranged to engage with said three sections of said second elongated slot respectively.

25. The spectacles frame, as recited in claim 23, wherein said first extension arm further has a first engagement channel indently formed on said first transverse surface, said first accessory member comprising a first engagement sleeve formed on a front surface thereof in such a manner that said first engagement sleeve is arranged to detachably insert into said first engagement channel.

26. The spectacles frame, as recited in claim 24, wherein said second extension arm further comprising a second engagement channel indently formed on said second transverse surface, said second accessory member comprising a second engagement sleeve formed on a front surface thereof in such a manner that said second engagement sleeve is arranged to detachably insert into said second engagement channel.

27. The spectacles frame, as recited in claim 25, wherein said first extension arm has a first extension portion.

28. The spectacles frame, as recited in claim 26, wherein said second extension arm has a second extension portion.

29. The spectacles frame, as recited in claim 14, wherein said personal accessory further comprises a third accessory member comprising a reflective medium coated on said lenses.

30. The spectacles frame, as recited in claim 28, wherein said personal accessory further comprises a third accessory member comprising a reflective medium coated on said lenses.
